(19) United States
(12) Patent Application Publication
(10) Pub. No.: US 2026/0156554 A1
(43) Pub. Date: Jun. 4, 2026

(54) SOFTWARE DEFINED ELEVATION BASED NON-TERRESTRIAL NETWORK ACCESS

(71) Applicants: AT&T Intellectual Property l, L.P., Atlanta, GA (US); AT&T Mobility ll LLC, Atlanta, GA (US)

(72) Inventors: Sreejith Menon, Herndon, VA (US); Thomas Becker, Atlanta, GA (US); Debasis Basu, Marlboro, NJ (US)

(73) Assignees: AT&T Intellectual Property l, L.P., Atlanta, GA (US); AT&T Mobility ll LLC, Atlanta, GA (US)

(21) Appl. No.: 18/967,773

(22) Filed: Dec. 4, 2024

(51) Int. Cl. H04W 36/32; H04W 48/18; H04W 60/04; H04W 64/00; H04W 84/06

(52) U.S. Cl. CPC H04W 36/328; H04W 48/18; H04W 60/04; H04W 64/00; H04W 84/06

(57) ABSTRACT

Aspects of the subject disclosure may include, for example, attaching, by a radio circuit, to a terrestrial radio network for radio communications with the terrestrial radio network, monitoring an altitude of the radio circuit relative to a surface of earth, and attaching, by the radio circuit, to a non-terrestrial radio network for subsequent radio communication with the non-terrestrial radio network to limit radio interference on the terrestrial radio network, wherein the attaching to the non-terrestrial radio network is responsive to the altitude of the radio circuit exceeding a first elevation threshold value. Other embodiments are disclosed.

### FIELD OF THE DISCLOSURE

The subject disclosure relates to a system and method for accessing a non-terrestrial communications network by user equipment (UE) in a satellite direct to cellular communications system.

### BACKGROUND

There is a growing demand for and use of aerial user equipment (UEs), such as drones, helicopters, and airplanes equipped with cellular radios and using a cellular network for communication. This increasing demand requires an effective strategy by a mobile network operator to best serve those aerial UEs without impacting terrestrial network capacity, nor affecting the terrestrial user performance.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communications network of FIG. 1 in accordance with various aspects described herein.

FIG. 2B is a block diagram illustrating an example, non-limiting embodiment of a system functioning within the communications network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for an intelligent user equipment (UE) that can decide when to look for a terrestrial or aerial network based on its altitude. The UE can attach to a terrestrial network, monitor its altitude and, when the altitude exceeds a threshold, attach to a non-terrestrial network to thereby reduce interference in the terrestrial network. Other embodiments are described in the subject disclosure.

One or more aspects of the subject disclosure include attaching, by a user equipment (UE) capable of radio communication, to a first radio network, determining, by the processing system, an altitude of the UE relative to a surface of earth, comparing, by the processing system, the altitude of the UE with an elevation threshold value, when the altitude of the UE exceeds the elevation threshold value, selecting, by the processing system, a second radio network, and attaching, by the processing system, to the second radio network for future network communications.

One or more aspects of the subject disclosure include detecting a terrestrial radio network, determining the terrestrial radio network is a permitted radio network, attaching to the terrestrial radio network, monitoring an altitude of the device, determining the altitude of the device has exceeded an elevation threshold value, identifying a non-terrestrial radio network as a permitted radio network, attaching to the non-terrestrial radio network while de-attaching from the terrestrial radio network and communicating with the non-terrestrial radio network.

One or more aspects of the subject disclosure include attaching, by a radio circuit, to a terrestrial radio network for radio communications with the terrestrial radio network, monitoring an altitude of the radio circuit relative to a surface of earth, and attaching, by the radio circuit, to a non-terrestrial radio network for subsequent radio communication with the non-terrestrial radio network to limit radio interference on the terrestrial radio network, wherein the attaching to the non-terrestrial radio network is responsive to the altitude of the radio circuit exceeding a first elevation threshold value.

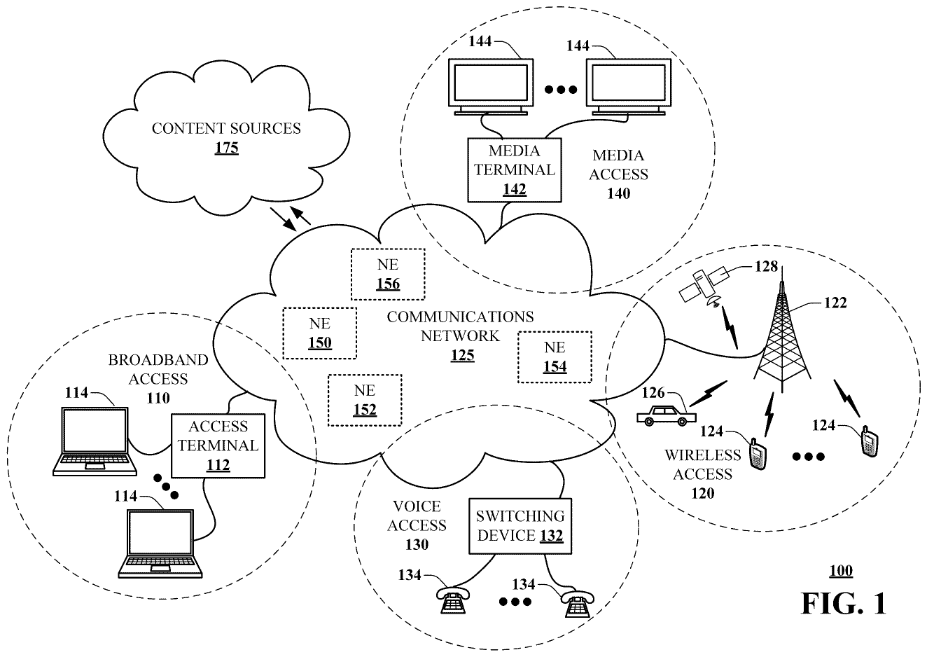

Referring now to FIG. 1, a block diagram is shown illustrating an example, non-limiting embodiment of a system 100 in accordance with various aspects described herein. For example, system 100 can facilitate in whole or in part a UE that can attach to a terrestrial network, monitor its altitude and, when the altitude exceeds a threshold, attach to a non-terrestrial network to thereby reduce interference in the terrestrial network. In particular, a communications network 125 is presented for providing broadband access 110 to a plurality of data terminals 114 via access terminal 112, wireless access 120 to a plurality of mobile devices 124 and vehicle 126 via base station or access point 122 and/or via satellite 128, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite 128 can be configured for bi-directional communication with one or more access points, with one or more base stations, and/or with one or more mobile devices (e.g., direct-to-cell). In various embodiments, the satellite 128 can comprise a Low Earth Orbit (LEO) satellite or a Geostationary Orbit (GEO) satellite.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

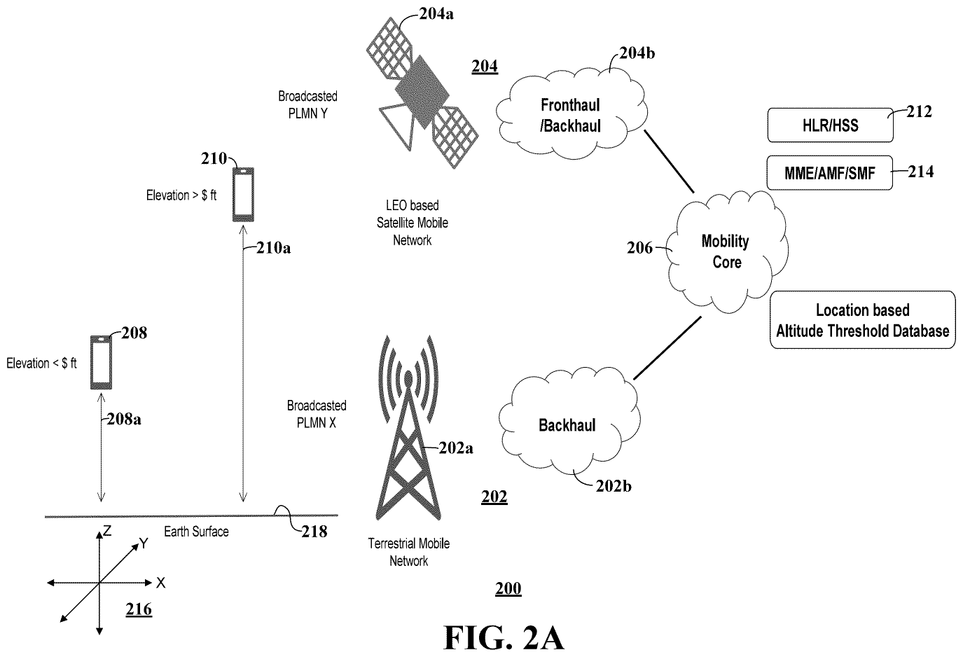

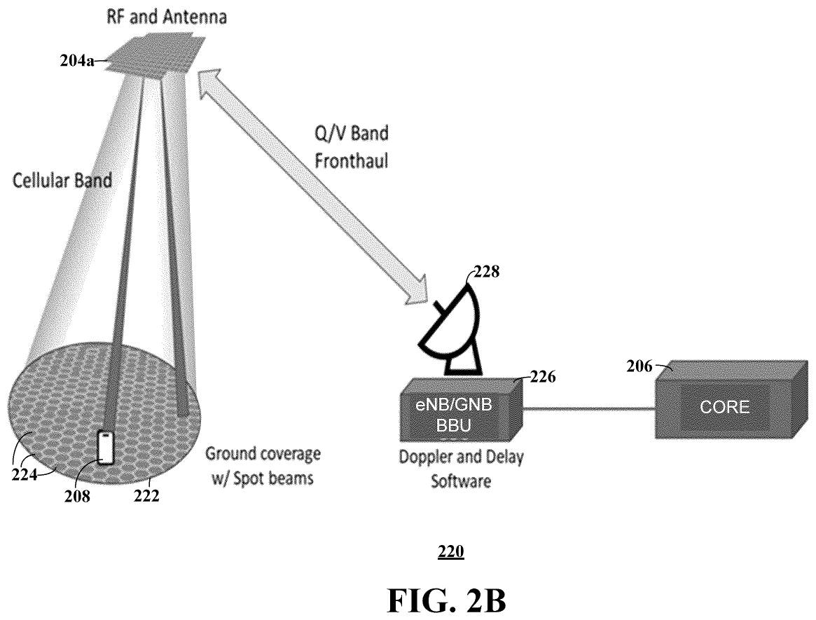

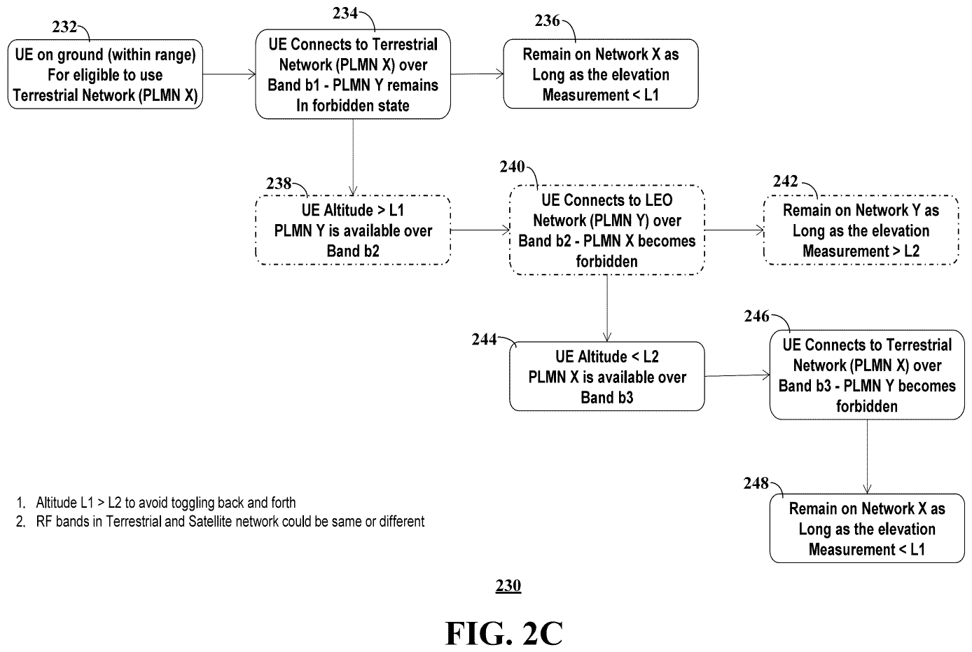

FIG. 2A is a block diagram illustrating an example, non-limiting embodiment of a system 200 functioning within the communication network of FIG. 1 in accordance with various aspects described herein. FIG. 2A may include a direct to cellular or direct to cell communication system. Thus, the system 200 includes a terrestrial network 202 and a satellite or non-terrestrial network 204. Both the terrestrial network 202 and the non-terrestrial network 204 are in data communication with a mobility core network 206. Further, both terrestrial network 202 and the non-terrestrial network 204 may provide telecommunication service to mobile devices or user equipment (UEs) such as UE 208 and UE 210.

The terrestrial network 202 or TN may be termed a cellular network. Similarly, the non-terrestrial network 204 or NTN may be termed a satellite network. The terrestrial network 202 may include a variety of infrastructure elements for handling communication traffic. In the illustrated example, the terrestrial network 202 includes one or more base stations such as base station 202a and backhaul network 202b. Data between base stations and the mobility core is communicated over the backhaul network 202b. Similarly, the non-terrestrial network 204 may include a variety of infrastructure elements for handling communication traffic. In the illustrated example, the non-terrestrial network 204 includes one or more satellites such as satellite 204a and a fronthaul/backhaul network 204b. Data between the satellites and the mobility core network 206 is communicated over the fronthaul/backhaul network 204b.

In embodiments, the terrestrial network 202 may be owned and operated by a mobile network operator (MNO), also referred to as a cellular service provider (CSP). The CSP may also operate the non-terrestrial network 204 or may partner with a separate organization operating the satellite network or non-terrestrial network 204. The terrestrial network 202 and the non-terrestrial network 204 may cooperate to provide communication services to the same group of users. A user's device, or user equipment (UE), may communicate with the terrestrial network 202 and the non-terrestrial network 204, depending on network availability for the location of the UE and other factors.

The mobility core network 206 provides a variety of centralized functions for the terrestrial network 202 and the non-terrestrial network 204. Such functions may include mobility management, accounting and authorization and others. Further, the mobility core network 206 may include one or more gateways to other networks such as the public internet.

Mobility management may include tracking location of UEs such as UE 208 and UE 210 and maintaining connection to one of the terrestrial network 202 and the non-terrestrial network 204, or both. In example embodiments, the mobility core network 206 includes a home location register (HLR) 212 and home subscriber server (HSS). The HLR 212 stores information about subscribers including an international mobile station identifier (IMSI). The HLR 212 acts as a central repository for user and device data. The HSS stores subscriber information and handles functions such as authentication, authorization and location tracking for mobile devices. In embodiments, the mobility core network 206 may further include a visitor location register VLR which stores temporary information about a mobile device such as UE 208 or UE 210 while it is roaming in a particular network.

Related functions performed by the mobility core network 206 as illustrated in the drawing figure include core feature 214 providing a mobility management entity (MME), an access and mobility management function (AMF), and a session management function (SMF). The MME tracks locations of UE devices and enables handover of communications between base stations of the terrestrial network 202 and satellites of the non-terrestrial network 204, as well as between the terrestrial network 202 and the non-terrestrial network 204. The AMF manages functions such as user registration and authentication and session management for a UE. The SMF manages functions such as protocol data units (PDU) sessions between a UE and the network, establishes and maintains appropriate quality of service (QoS) for a UE and enforces network policies involving network traffic.

As is indicated in FIG. 2A, the terrestrial network 202 is identified by a public land mobile network (PLMN) identifier, indicated as PLMN X. Similarly, the non-terrestrial network 204 is identified by a PLMN identifier, indicated as PLMN Y. For each network, the PLMN is a unique code consisting of a country code and a mobile network code. Each PLMN is operated by a single service provider although the same provider may operate both the terrestrial network 202 and the non-terrestrial network 204. Base stations such as base station 202a and satellites such as satellite 204a periodically broadcast system information blocks (SIBs) over the radio interface. Such SIBs contain information about the serving PLMN including its country code and mobile network code. UEs such as the UE 208 and the UE 210 continuously monitor such broadcasts to acquire information about available PLMNs and to select the appropriate network for registration.

For example, when a UE powers on or enters a new coverage area, it initiates an initial attach procedure with the network. During this procedure, the network provides the UE with the PLMN ID of the serving network. The UE can select the appropriate network based on the received PLMN identifier and other factors like signal strength and operator preferences. When a UE roams to a different PLMN, the network provides the UE with the PLMN ID of the visited network. The PLMN identifier corresponds to which core network the UE will interact with for functions such as access and authorization and mobility management. The PLMN identifiers in examples here correspond to a logical separation; the separation defined by the PLMN identifiers need not be a physical separation.

UEs including UE 208 and UE 210 may access either the terrestrial network 202 or the non-terrestrial network 204. UEs may generally include any type of device capable of radio communication with the terrestrial network 202 or the non-terrestrial network 204. Examples include smartphones, connected vehicles and internet of things (IoT) devices. Many of these UEs are located on or near the surface of the Earth. Moreover, some UEs may be aerial UEs which operate at an altitude or elevation above the surface of the Earth. Such aerial UEs may fly under their own power or be carried aloft by some other means. Some UEs may move between operation at or near the surface of the Earth and aerial operation. Examples of such aerial UEs include drones, helicopters and airplanes.

In general, cellular networks have been designed and built to provide service to UEs located on or near the ground. A typical UE accessing the network is in a vehicle on a roadway, carried by a user, or in a building a few floors or less above the ground. The network has been built around such use cases and is designed to provide coverage to devices relatively close to the ground or surface of the Earth. Thus, the UE only receives signals from and communicates with a small number of cell towers in its vicinity. However, when a UE is elevated or is airborne, the UE in effect sees many more cell towers, and the additional cell towers may appear as interferers to the UE. Similarly, when the UE is airborne, it appears as an interferer to many more cell towers that are outside of a line of sight when the UE is on or near the ground.

Growing demand and use of such aerial UEs using cellular network requires an effective strategy by the mobile network operator to best serve those aerial UEs without impacting terrestrial network capacity, nor affecting the terrestrial user performance. Having a dedicated network for aerial UEs avoids the interference issues caused by the aerial UEs camping on the terrestrial cellular network. However, traditionally, no cellular network operator built out mobile infrastructure, including radios and antennas, keeping aerial UEs in mind. Building a new infrastructure with antenna tilting upwards using a dedicated RF band or other satellite based mobile infrastructure solution could be an alternative. However, recently, non-terrestrial networks such as the non-terrestrial network 202 have been adopted for such use cases. Users expect to have their mobile handsets work seamlessly when they are in ground mode, operating on or near the ground, or in aerial mode, operating while airborne. A dedicated UE only for aerial use may not be commercially acceptable. Rather, an intelligent UE deciding when to look for a terrestrial network or an aerial network based on its location, including its altitude) may be more commercially viable, especially from a user adoption perspective.

Known technologies for communicating with elevated UEs are not practical for implementation. A mobile network operator may tilt antennas at base stations in a vertical direction to provide coverage to areas above the ground. However, this may require providing duplicate coverage, both high and low, and may be too expensive to be feasible. Some airplanes are equipped with satellite connections and include a dedicated antenna and radio along with software to maintain a radio connection to a geostationary satellite. However, such an implementation is not practical for applications such as a drone or other airborne UE.

A UE communicates with a satellite such as satellite 204a and with a base station such as base station 202a using both uplink (UL) and downlink (DL) signals. The uplink is the radio connection from a device such as the UE 208 to the base station 202a or the satellite 204a. For example, the network may have a defined physical uplink shared channel (PUSCH). The PUSCH carries user data from the UE to network infrastructure. The PUSCH is a shared channel, to be used by multiple UEs. The infrastructure, such as the base station 202a or the satellite 204a, schedules transmission of data on the PUSCH such as by allocating specific time and frequency resources to each UE. Another example of an uplink channel is a physical random-access channel or PRACH. The PRACH is used by a UE to send a request to the network infrastructure to join the network. The network infrastructure then allocates resources necessary for the UE to communicate, such as time slots and frequency bands. The downlink is the radio connection from the base station 202a or the satellite 204a to the UE 208.

Due to uplink and downlink interference, supporting aerial UEs on a terrestrial network such as terrestrial network 202 has been problematic. In the DL, some aerial UEs experience radio conditions similar to those experienced by UEs in a terrestrial network at the edge of a cell, where coverage can be poor and signal to interference plus noise ratio (SINR) can be unacceptably high. The percentage of aerial UEs experiencing cell-edge like radio conditions such as poor DL SINR is much higher as compared to terrestrial UEs. This is because aerial UEs have a high line-of-sight propagation probability. They are elevated and therefore in the line-of-sight of a relatively large number of base stations. As a result, such aerial UEs receive DL interference from a larger number of cells than a typical terrestrial UE does. In the DL, there is a higher probability that the number of neighboring cells causing a high level of DL interference at the aerial UEs is higher than in the case of terrestrial UEs. Due to downlink interference from multiple cells received at aerial UEs, increasing the ratio of aerial UEs requires a higher resource utilization level to compensate for the high level of DL interference and to deliver the same offered cell data traffic. The increase in resource utilization level further decreases the spectral efficiency in the network, which in turn degrades downlink throughput performance of both aerial UEs and terrestrial UEs.

The presence of aerial UEs increases the UL interference of both aerial and terrestrial UEs. Since the aerial UEs experience line-of-sight propagation conditions to more cells with higher probability than terrestrial UEs, the aerial UEs cause more interference to more cells in the uplink than a typical terrestrial UE does. Hence, the increase in UL IoT with increasing ratio of aerial UEs is due to aerial UEs causing more uplink interference to multiple cells. Due to uplink interference caused by aerial UEs, increasing the ratio of aerial UEs requires higher resource utilization level to deliver the same offered cell data traffic. The uplink interference caused by aerial UEs degrades throughput performance of terrestrial UEs. The increase in resource utilization level further increases interference in the network, which in turn degrades uplink throughput performance of both aerial UEs and terrestrial UEs.

Increased uplink interference may also cause performance degradation on UL channels other than PUSCH. Under strong interference on PRACH resources, successful detection rate of PRACH can be degraded and the UE may transmit with maximum transmission power as a result of power ramping. It may cause further increase in terms of uplink interference and potential risk for the base station, also referred to as the eNodeB or eNB, to experience too strong reception power.

To address the noted problems, the system 200 may implement an altitude-based trigger for network selection. A UE links to a particular network based on the altitude or distance above the surface of the earth. In embodiments, this may refer to the position of the UE along a z-axis, using the coordinate system 216 shown in FIG. 2A relative to the surface 218 of the earth. Thus, in the drawing figure, UE 208 has an elevation 208a and the UE 210 has an elevation 210a. The elevation 208a and the elevation 210a are determined along a z axis of the coordinate system 216 relative to the surface 218 of the earth. Thus, in the example, UE 210 is at a higher elevation than UE 208 because UE 210 is a farther distance from the surface 218 of the earth than the UE 208.

In embodiments, a UE may be defined in the broadest terms. In FIG. 2A, the UE 208 and the UE 210 are each illustrated as smartphones or similar devices which may be handheld by respective users. In other embodiments, one or both UEs may be embodied as a drone. A drone, also known as an unmanned aerial vehicle (UAV) or unmanned aircraft system (UAS), is an aircraft without a human pilot on board. Drones can be remotely controlled by a human operator or fly autonomously using software-controlled flight plans. Generally, a drone has a propulsion system such as one or more propellers or rotors powered by one or more electric motors. The drone can include other components or equipment, such as cameras and other sensors. Further, the drone can include a mobile radio transceiver configured for radio communication with a mobility network such as a fourth generation (4G or LTE) cellular network, a fifth generation (5G) cellular network, a sixth generation (6G) cellular network, or other follow-on network or other type of radio network. The radio transceiver enables two-way communication between the drone or other UE and a terrestrial network such as terrestrial network 202 and a non-terrestrial network such as non-terrestrial network 204. In addition to a smartphone or other handheld device and a drone, the UE 208 or the UE 210 may be embodied in any other type of device including being carried by another device capable of being airborne or operating at a variety of elevations. For example, the UE could be a smartphone of IoT device carried by a human passenger in a helicopter as the helicopter ascends from the ground on a flight.

In embodiments, a threshold elevation is set for the UE for selection of a network to select for attachment. Attachment generally includes locating network infrastructure providing a suitable signal, authenticating the UE to the network based on identification information for the UE and a subscriber account, and accessing services of the network. In the illustrated example of FIG. 2A, the UE 208 and the UE 210 may attach to either the terrestrial network 202 or the non-terrestrial network 204.

Continuing the example of the UE embodied as a smartphone or IoT device carried by a human passenger in a helicopter, when the helicopter is on the ground below the threshold elevation, the UE attached to the terrestrial network 202 in a conventional manner. The radio access network features of the terrestrial network 202 are well adapted to manage and minimize interference and other interaction between the UE and other interferers in the area.

As noted, the selection of a network for the UE is based on a height threshold or an elevation threshold. When the UE moves above the elevation threshold, the UE is proactively steered towards attachment to a satellite or low earth orbit (LEO) network such as non-terrestrial network 204. After the UE moves beyond a certain height defined according to the elevation threshold, the UE should only select the non-terrestrial network for attachment. Further, after moving beyond that certain height or elevation, the UE should not attempt to retain its existing attachment to the terrestrial network 202 or try to attach to the terrestrial network 202.

The altitude (i.e., z-axis) information for the UE can be determined using any suitable technique. In one example, the altitude or elevation can be determined at the UE based on barometric sensors. For example, the UE may include a micro-electromechanical sensor (MEMS) barometric sensor to provide elevation or altitude information for the UE. In another example, the altitude or elevation of the UE can be determined by the UE itself or the network to which the UE is attached based on triangulation of multiple beacons or other signals communicated by the UE or network infrastructure. In another example, the altitude or elevation of the UE can be determined based on global positioning system (GPS) data, etc. For example, the UE may include a radio circuit configured to receive GPS broadcast data from satellites in earth orbit and determine location and elevation information accordingly. In examples, a combination of MEMS barometric sensor and GPS may be used by the UE to determine its own altitude and elevation information. The determined elevation information can be used to compare against a set elevation threshold value to determine which network to access, the terrestrial network 202 or the non-terrestrial network 204. In embodiments, elevation be defined in any suitable manner.

Any suitable network-to-network handover mechanism or procedure may be established. In one example, the mobility core network 206 may receive from one or both of the terrestrial network 202 and the non-terrestrial network 204 information about the current elevation of the UE. If the UE detects its own elevation, the UE may routinely report its current elevation to the network to which it is attached. When network infrastructure such as the mobility core network 206 determines that the UE has crossed the elevation threshold, the mobility core network 206 may signal to the UE through the current serving network that the UE should handover from the current serving network to the target network. In this example, the current serving network in the terrestrial network 202 and the target serving network is the non-terrestrial network 204.

The elevation threshold used for comparison and for the network selection decision may be configurable. In one example, the elevation threshold may be defined to include a threshold, such as 1000 meters±100 meters. This may help account for inaccuracies in measurement and timing. In another example, in some embodiments, the threshold may be configurable by the mobile network operator.

A selected threshold for the network selection decision may be based, for example, on the current location of the UE. For example, major cities with high-rise buildings and terrestrial antennas built on top of buildings or hills may use a different threshold than a flat rural area where antennas are located on or near the ground. Any suitable information, such as GPS coordinates or a tracking area code (TAC) indicator value may be used to determine location information for the UE and to determine that the UE is in an area of high-rise buildings and should use a different or modified elevation threshold. The TAC indicator is a unique identifier assigned to a group of cells in a cellular network and used to manage and track the location of mobile devices within a specific geographical area.

Thus, the elevation threshold sets a vertical trigger for handover from one network to the other, such as from the terrestrial network to the non-terrestrial network. The movement of the UE vertically past the altitude of the elevation threshold triggers the inter-network handover, which may be an inter-PLMN handover. Also, handover may be triggered based on horizontal movement as well. In an example, as the UE moves horizontally from location to location, network reselection may be triggered by the horizontal movement rather than vertical movement, as the UE moves into a region having a different elevation threshold. For example, in a city area with many high buildings, the elevation threshold may be set at 2000 meters while in surrounding suburban or rural areas, the elevation threshold may be set at 1000 meters. As the UE moves from the urban area, at 1500 meters, the horizontal movement into the region with the lower elevation threshold may trigger the inter-network handover.

In another example, the UE or a component of the network, such as the mobility core network 206, may operate to predict a future location of the UE based on current location, movement, and past history of the UE device or user. The network or the UE may schedule a network reselection based on the predicted future location.

The UE altitude change can be used to trigger the UE to select a specific network to camp on or to attach to. The UE may select either a terrestrial network such as terrestrial network 202, advertising PLMN X in FIG. 2A, or an aerial network such as non-terrestrial network 204, advertising PLMN Y in FIG. 2A. A switch between networks can be achieved in any suitable manner, including designating the terrestrial network 202 with a first PLMN (PLMN X) and designating the non-terrestrial network 204 with a second, different PLMN (PLMN Y). When the threshold is crossed, the network signals to the UE or the UE decides based on its own logic and sensors to make the switch and then selects the other PLMN for attachment.

In some embodiments, the switch from the first network, such as terrestrial network 202, to the second network, such as non-terrestrial network 204, may be seamless or transparent, and not readily detectable by a user of the EU. In other examples, a user of the UE may be notified of the handover including being given a notification before the actual handover occurs. Moreover, in some instances, the handover may not be completely seamless. For example, in some locations, satellite coverage is not complete. Satellites only provide coverage to a relatively small area and the coverage area moves over time with the orbit of the satellite above the earth. Thus, there may be a time delay between the triggering of the handover based on the elevation of the UE and completion of the handover. If the handover is triggered when the UE is not within a satellite coverage area, the UE may have no coverage and no service for a time until the location of the UE receives available satellite coverage. In some embodiments, the mobility core network 206 or other network element may detect a time misalignment between the timing of the handover trigger from a terrestrial network to a non-terrestrial network and the availability of coverage from the non-terrestrial network. To prevent an interruption in service to the UE by the combined networks, the handover may be delayed from the time of the trigger to a time when the network determines that the coverage from the satellite will again be available at the location of the UE.

The elevation threshold or altitude threshold may be based on any suitable factor or combination of factors. In one example, the elevation threshold may be defined by the mobile network operator to be a standard, static threshold, such as 200 feet above the surface 218 of the earth. In a second example, the elevation threshold may be a dynamic threshold defined by the mobile network operator. For example, the dynamic threshold may be based on location, such as a first threshold for urban environments with many tall buildings and a second threshold for flat or rural locations. In another example, the dynamic threshold may be based on key performance indicators (KPIs) in the two networks. One KPI is throughput, or the rate at which data is successfully transferred through the network. In areas or times when throughput values indicate network congestion in one of the networks, the mobility core network 206 may adjust the elevation threshold to proactively move traffic from one of the terrestrial network or the non-terrestrial network to the other network. Thus, the dynamic threshold may be adjusted for load balancing in the network.

In another example, the elevation threshold may be updated by over the air (OTA) updating. While the UE is operating on one of the available networks, the mobility core network 206 or other network infrastructure may communicate a command to the UE to revise the elevation threshold currently in use. For example, this may be done dynamically to respond to an incident such as a natural disaster requiring first responder participation. The OTA change may be made to get the first responders onto the proper network together or to get other subscribers off the preferred network for the first responders.

In another example, the elevation threshold may be performed manually and, for example, in response to OTA polling by the network infrastructure of the UE and other UE devices active on the network. For example, the UE is actively communicating in the air, on the non-terrestrial network. The UE observes a poor signal quality from the terrestrial network at its present location. The UE may communicate that information to the mobility core network 206, for example, on its own in response to the poor signal quality measurement or in response to an inquiry from the mobility core network 206. In response, the mobility core network 206 may instruct the UE and other UEs in the area to use the existing height of the UE as the new elevation threshold. A database may be used to store operating information such as current elevations thresholds for different regions. the database or other data store may be updated to reflect the change.

FIG. 2B is a block diagram illustrating an example, non-limiting embodiment of a system 220 functioning within the communications network 125 of FIG. 1 in accordance with various aspects described herein. FIG. 2B illustrates a low earth orbit (LEO) based mobility architecture for providing communication services to a user equipment (UE) 208 by a satellite 204a. The system 220 of FIG. 2B includes UE 208, satellite 204a, baseband unit (BBU) 226, and mobility core network 206.

The satellite 204a may be one of a constellation of satellites which provide communication services to UE equipment such as UE 208. The satellite is in low earth orbit and provides communication services to a service area 222. The service area 222 includes a number of spot beams 224. When the UE is in an area served by a spot beam of the spot beams 224, the UE may communicate with the satellite 204a. As indicated, the communication may be performed using a conventional frequency band assigned for terrestrial cellular communications, such as in the 900 MHz and 1900 MHz bands. Other bands may be used as well. The UE 208 may be located on or near the surface of the earth or may be airborne and operating in the coverage cone defined by the service area 222 and the satellite 204a. The satellite 204a moves in orbit around the earth and the coverage area or service area 222 including the spot beams 224 moves along with the satellite 204a.

For communication with other components of the system 220, the satellite 204a communicates fronthaul data with BBU 226 located on the ground. In the example, such communication uses Q band and V band frequencies. Other frequency bands may be used as well. In some examples, the satellite 204a may communicate with other satellites of a constellation. For example, as the satellites of the constellation move in orbit, the coverage area or service area 222 moves with the satellites. Thus, the UE 208 will be located in adjacent coverage areas from adjacent satellites as the constellation moves. The communication between the satellite 204a and the UE 208 may be handed off from the satellite 204a to the adjacent satellite.

The radio link between the satellite 204a and the BBU 226 handles fronthaul communication. Fronthaul generally refers to communication in a cloud radio access network (C-RAN) between a baseband unit and a remote radio head (RRH). In this example, the satellite 204a provides functionality associated with a RRH in a terrestrial network. Radio frequency (RF) signals for communication by the satellite 204a may be processed by the BBU. The mobility core network 206 provides control and further processing for the system 220.

Thus, the system 220 may overlay conventional cellular coverage in a particular area and enable interaction between non-terrestrial components of the system 220 and terrestrial components of the conventional cellular network. In addition, vertical handover between the two networks is applicable. One challenge is that the UE 208 generally has a stronger signal, with less interference, from base stations of the cellular network. Due to the better signal, the UE 208 would, on its own, never even try to attach to the non-terrestrial network. The vertical handover features described herein provides the UE with additional information to know when the UE 208 needs to attach to the terrestrial network and when it needs to attach to the satellite network, rather than remaining camped on one network.

FIG. 2C depicts an illustrative embodiment of a method 230 in accordance with various aspects described herein. The method 230 illustrates selection and attachment of a user equipment (UE) device to one of an aerial network or non-terrestrial network, such as a satellite network, and a terrestrial network such as a cellular network. The method 230 uses an elevation or height of the UE above the ground or surface of the earth to determine which network to attach to, and which network to remain attached to.

As indicated in the drawing figure, the exemplary embodiment of the method 230 makes use of two elevation threshold values, designated L1 and L2. The values of L1 and L2 may be set at any suitable value and may be updated or modified dynamically based on conditions such as location (e.g., urban versus rural), the presence of structures, terrain, satellite network coverage patterns, network traffic levels, and requirements of regulatory bodies such as the Federal Communications Commission and the Federal Aviation Administration. In typical applications, the value of L1 is maintained greater than L2, or as indicated in the figure, L1>L2. Example altitudes are L1=1000 meters and L2=750 meters. Any suitable values may be used and the values may be varied dynamically as indicated. This is set in embodiments to reduce the likelihood of toggling back and forth between the two networks and to create a type of hysteresis for the network selection logic.

As further noted in the drawing figure, radio frequency (RF) bands designated for the terrestrial network and the non-terrestrial network may be the same or different. In general, the UE communicates with both networks using conventional cellular frequency bands, such as 900 MHz and 1900 MHz. The ability to select the non-terrestrial network should be available to all conventional UEs including smartphones and other personal communication devices, IoT devices, and devices equipped with a cellular transceiver such as a drone or other airborne vehicle. In addition, individual satellites may communicate with other satellites or with ground equipment using conventional cellular frequency bands or frequency bands dedicated to or licensed for satellite communications.

The method 230 may be performed by a UE in cooperation with a satellite or other aerial or non-terrestrial network, and a cellular or other terrestrial network. The method may be performed under control of or under supervision of or with assistance from any suitable components of the terrestrial network, the non-terrestrial network, or both. In the example embodiment of FIG. 2A, the mobility core network 206 supervises selection and attachment of the UE 208 and the UE 210 with the respective networks. Such supervision may include, for example, communicating with the UE information about what networks the UE is entitled to access (e.g., according to a PLMN identifier), communicating to the UE information about elevation thresholds or at which altitude the UE should reselect a network.

Procedures for attachment to the network may be conventional and in accordance with published air interface standards such as those published by the 3d Generation Partnership Project (3GPP®; 3GPP is a registered trademark of the 3d Generation Partnership Project). 3GPP publishes and is responsible for development and maintenance of standards related to GSM, 2G and 2.5G, including GPRS and EDGE; UMTS and related 3G standards; LTE and related 4G standards; 5G NR and related standards; 6G and related standards; and other follow-on radio technology and mobile communication standards.

At step 232, the UE is located on or near the ground or surface of the earth and within range of a cellular base station or other radio access network (RAN) element of the terrestrial network. Further, the UE is eligible to use the terrestrial network. Eligibility to use the terrestrial network may include association of the UE with a subscriber account with a mobile network operator associated with the network, and provisioning to access the terrestrial network. In the drawing figure, the terrestrial network is identified by a public land mobile network identifier PLMN X.

While the UE is on the ground or at an elevation or altitude less than L1, the UE may be forbidden to access the non-terrestrial network, identified in this example as PLMN Y. This blocking of access may be done in any suitable manner, such as excluding the identifier PLMN Y from a list of PLMN identifiers to which access is permitted. For example, the mobility core network 206 (FIG. 2A) may communicate information about permitted PLMN identifiers. Such information may be based on a combination of provisioning information for the UE and operation of the method 230. In embodiments, information about forbidden PLMN identifiers and permitted PLMN identifiers may be stored at a subscriber identity module (SIM) card of the UE. Such stored information may be consulted when the UE seeks to attach to a network.

At step 234, the UE connects to the terrestrial network, identified as PLMN X. In the example, the UE uses a frequency band identified as band b1 to connect to a base station of the terrestrial network. The connection and attachment operation of step 234 may be conventional. The UE may be stationary at a particular location on the ground, or the UE may be mobile and actively handing off communication among cellular base stations (eNodeB and gNodeB devices) of the terrestrial network.

At step 236, the UE remains on the terrestrial network, identified as PLMN X, so long as the elevation measurement for the UE remains less than the value of L1. In an example in which L1 is set at 100 meters, the UE and an individual carrying the UE may move around the terrain and up into buildings and structures without triggering an inter-network handover. As the UE moves, the UE may experience intra-network handover as communication with the UE is handed off from one base station of the terrestrial network to another. In general, network procedures for maintaining high quality, reliable, low-interference communication with the UE may be employed as the UE operates on the terrestrial network during step 236.

At step 238, the elevation or altitude of the UE is determined to exceed the first elevation threshold, L1, or 100 meters in the current example. The elevation of the UE may be determined in any suitable manner, such as by GPS measurement and calculation, barometric pressure determination, and triangulation from know reference points. The determination of the elevation of the UE may be made by the UE, by one or more infrastructure elements such as base stations of the terrestrial network, or a combination of these. The determination of the elevation of the UE may be made with any suitable accuracy or tolerance. The UE may determine its own elevation and proceed according to onboard network selection logic to determine a proper course of action. Alternatively, the UE may be advised of its elevation by one or more components of the terrestrial network. In an example, a base station of the terrestrial network may communicate a radio resource control (RRC) message to the UE advising of the current elevation or communicating a command to reselect the network, including providing a target PLMN identifier, PLMN Y, for the non-terrestrial network. The RRC message or other communication may specify a frequency band for communication, such as band b2. Any other suitable information may be communicated to or retrieved from storage at the UE to perform the inter-network handover.

In some applications, the UE may be a smartphone or other device with full processing, data storage and communication capabilities. In such an application, substantial processing and decision making may be devolved to the UE operating on the two networks. In other applications, the UE may be an IoT device with more limited processing, data storage and communication capabilities. For example, the IoT device may include a sensor such as a camera and have relatively data processing capabilities beyond processing images or video data. Further, the IoT device may be a reduced bandwidth (RB) device with limited communication capabilities. For such an application, a greater degree of control is retained at the network level, including measuring UE altitude and initiating inter-network handover for the UE.

At step 240, responsive to the altitude exceeding L1, the UE connects to the non-terrestrial network, indicated in the drawing figure as a low earth orbit (LEO) satellite network. The UE may detect and attach to the network associate with PLMN identifier PLMN Y, as the PLMN identifier PLMN Y is no longer forbidden but becomes a permitted PLMN. In this example, the terrestrial network identified by PLMN identifier PLMN X becomes forbidden for attachment. This changing of status for the PLMN identifiers, between forbidden and permitted, may be achieved by communicating such information to the UE from the network. Alternatively, the PLMN identifiers may be stored at the UE along with an elevation or altitude indicator and a permission indicator. Thus, the PLMN identifier PLMN X may be stored with data for “permitted below L1,” and the PLMN identifier PLMN Y may be stored with data for “permitted above L1.” When the UE receives updated altitude information, either from onboard sensors or determination or from the network the UE may use the updated altitude information along with the stored data to identify a permitted PLMN identifier and frequency band. If a change is indicated, the UE may initiate an inter-network handover.

In some applications or instances, the switch from the terrestrial network PLMN X to the non-terrestrial network PLMN Y may be delayed, either intentionally or in effect. The non-terrestrial network may not provide full-time coverage at the location of the UE. As indicated in FIG. 2B, coverage areas move with the orbiting satellite, and the call for inter-network handover may occur when the UE is in an area with no satellite coverage or poor satellite coverage. As a result, the UE may defer the inter-network handover until satellite coverage becomes available. This may be done, for example, simply by sensing for the presence of the PLMN identifier PLMN Y, or in response to a command from the terrestrial network. For example, the terrestrial network may have awareness of timing and location of satellite coverage, as well as of the location and movement of the UE. The network may process this information to identify a time and place appropriate for completion of the inter-network handover.

At step 246, the UE remains attached to the non-terrestrial network identified as PLMN Y so long as the elevation measurement remains above a second elevation threshold designated L2. As noted, L2 may be selected to be less than L1 by any suitable amount to prevent toggling by the UE back and forth between the two networks as the UE travels at an elevation selected for inter-network handover. In FIG. 2C, step 238, step 240 and step 240 are shown in dashed lines to indicate they correspond to communication with the non-terrestrial network.

At step 244, if the elevation or altitude of the UE falls below the second elevation threshold, having a value of L2 in this example, the terrestrial network may become available to the UE for attachment. This may be done, for example, communicating the PLMN identifier for the terrestrial network, PLMN X, with a value of available to the UE. Alternatively, this may be done by storing the PLMN identifier in memory of the UE with the value for L2 and an indication that attachment is permitted for altitudes below L2. The designated or selected frequency band b3 may be specified as well.

At step 246, the UE performs inter-network handover and attaches to the terrestrial network, identified as PLMN X. This may be done using the designated frequency band b3 or any other suitable frequency band. Further in step 246, the PLMN identifier associated with the non-terrestrial network may become designated as forbidden to the UE for attachment.

At step 248, the UE remains attached to the terrestrial network, identified as PLMN X, so long as the elevation or altitude of the UE remains less than a value of L1. That is, so long as the UE is on or relatively near the ground or the earth's surface, as indicated by the value of L1, the UE will remain attached to the terrestrial network or cellular network. If the altitude of the UE exceeds the value of L1, control returns to step 238 to perform another inter-network handover to the terrestrial network.

Thus, three different triggers may be involved in the inter-network handover. A first trigger is the elevation or altitude of the UE. Generally, that is measured or obtained by the UE itself. A second trigger is the elevation threshold or thresholds, meaning the altitude at which the handover or handovers should occur. That information is generally provided by the network to the UE. It may be provided dynamically. A third trigger is information about what network the UE may access during an inter-network handover. In the example, this is defined as permitted PLMNs and forbidden PLMNs, but any suitable network identification information may be used to identify permitted networks and forbidden or prohibited networks. That information is generally stored in the SIM card of the UE and is provided by the network such as with provisioning information.

In some embodiments, the terrestrial network and the non-terrestrial network may be commonly operated by a single mobile network operator. In an example, the mobile network operator may elect to use the same network identifiers such as the same PLMN identifier for both the terrestrial network and the non-terrestrial network, but use different access frequencies for the two networks. A first frequency band may be assigned to or associated with the terrestrial network and a second frequency band may be assigned to or associated with the non-terrestrial network. In that case, the inter-network handover may be triggered by the elevation or altitude of the UE, as in the illustrated examples. However, the trigger is used to select the specific frequency band that is assigned to the non-terrestrial network. Below that elevation threshold, the UE may be forbidden from selecting the band that is used for satellite or non-terrestrial communications.

In accordance with embodiments herein an aerial UE such as a drone, or a drone equipped with a UE transceiver, may be readily operated out of a line of sight of an operator. Conventional drones attach to a local radio network or a non-terrestrial network and receive command and control information over the available network. This generally limits drone operation to line of sight of the local radio transceiver or a satellite. However, a drone incorporating features in accordance with various aspects described herein can selectively operate on multiple networks, using the same or different frequency bands, at substantial distance from an operator and a local radio network. Upon gaining elevation past the elevation threshold, the drone can automatically or under remote control switch to the satellite or other aerial network for operation at a distance.

Moreover, the aerial UE such as a drone or other device is removed as a source of interference once it completes the inter-network handover. After the handover, the UE no longer communicates with the terrestrial network and so does not create interference on the terrestrial network, despite operating at an elevation which would otherwise cause substantial interference.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

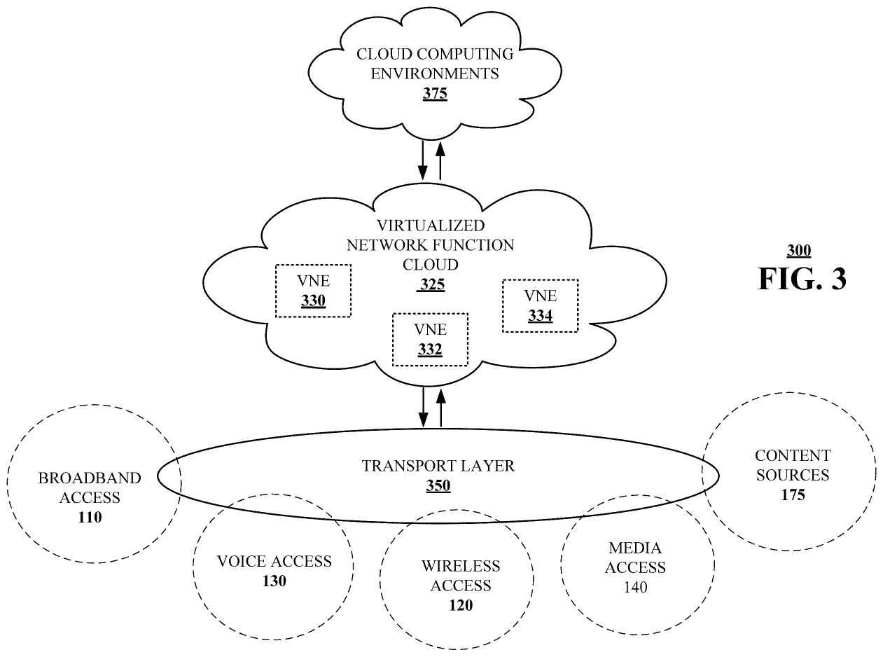

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, system 220, and method 230 presented in FIG. 1, FIG. 2A, FIG. 2B, FIG. 2C, and FIG. 3. For example, virtualized communication network 300 can facilitate in whole or in part enable a user equipment (UE) to attach to a terrestrial network, monitor its altitude and, when the altitude exceeds a threshold, attach to a non-terrestrial network to thereby reduce interference in the terrestrial network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

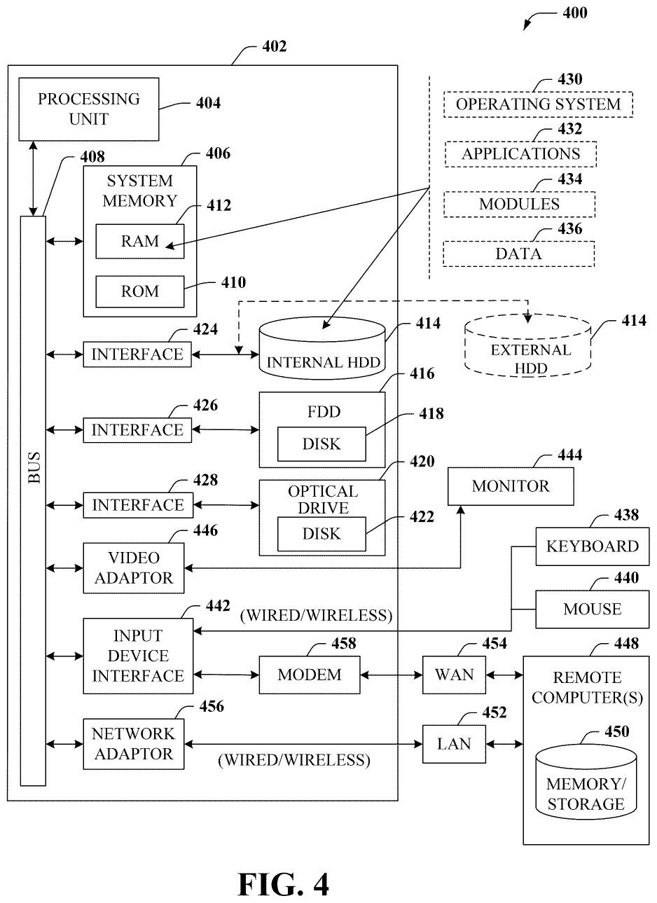

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part enabling a user equipment (UE) to attach to a terrestrial network, monitor its altitude and, when the altitude exceeds a threshold, attach to a non-terrestrial network to thereby reduce interference in the terrestrial network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

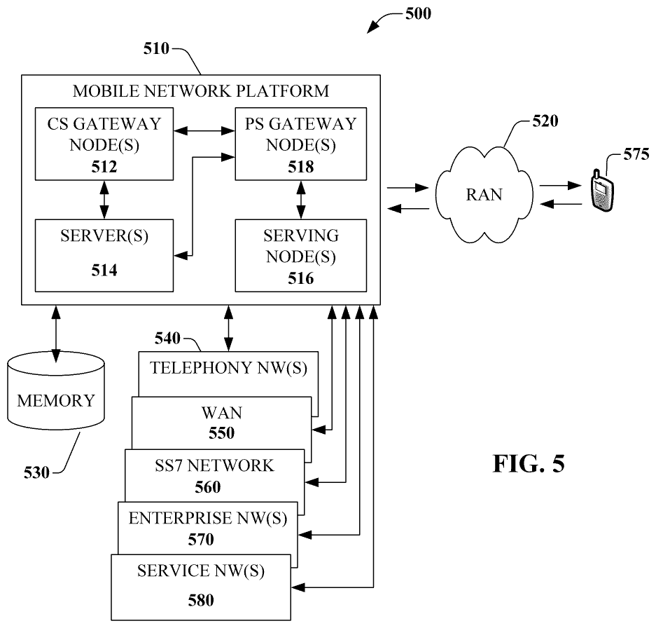

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part enabling a user equipment (UE) to attach to a terrestrial network, monitor its altitude and, when the altitude exceeds a threshold, attach to a non-terrestrial network to thereby reduce interference in the terrestrial network. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

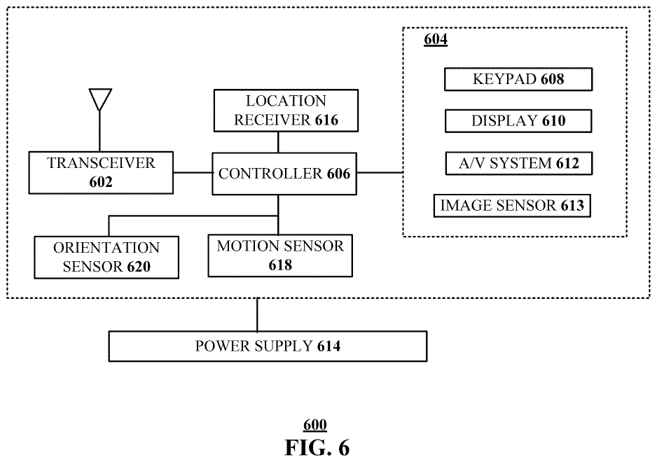

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part enabling a user equipment (UE) such as communication device 600 to attach to a terrestrial network, monitor its altitude and, when the altitude exceeds a threshold, attach to a non-terrestrial network to thereby reduce interference in the terrestrial network. In embodiments, the communication device 600 may be embodied as a drone or incorporated into a drone that is capable of beyond-line-of-sight operation. When the drone moves out of the immediate line of sight of a terrestrial control network, the drone may communicate on the non-terrestrial network for operation over the horizon.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
attaching, by a processing system including a processor of a user equipment (UE) capable of radio communication, to a first radio network;
determining, by the processing system, an altitude of the UE relative to a surface of earth;
comparing, by the processing system, the altitude of the UE with an elevation threshold value;
when the altitude of the UE exceeds the elevation threshold value, selecting, by the processing system, a second radio network; and
attaching, by the processing system, to the second radio network for future network communications.

2. The method of claim 1, further comprising:
comparing, by the processing system, a current altitude of the UE with a second elevation threshold value; and
reattaching, by the processing system, to the first radio network, wherein the reattaching is responsive to the current altitude of the UE falling below the second elevation threshold value.

3. The method of claim 2, wherein the comparing the current altitude of the UE with the second elevation threshold value comprises:
comparing, by the processing system, the current altitude of the UE with an elevation threshold value that is less than the elevation threshold value.

4. The method of claim 1, comprising:
determining, by the processing system, a current location of the UE;
determining, by the processing system, a current elevation threshold value, wherein the current elevation threshold value is based on the current location of the UE; and
comparing, by the processing system, the altitude of the UE with a current elevation threshold value.

5. The method of claim 4, comprising:
receiving, by the processing system, an updated elevation threshold value; and
updating, by the processing system, the current elevation threshold value based on the updated elevation threshold value.

6. The method of claim 1, further comprising:
communicating, by the processing system, with the first radio network;
determining, by the processing system, radio interference on the first radio network;
selecting, by the processing system, the second radio network, wherein the selecting the second radio network is responsive to the radio interference on the first radio network exceeding an interference threshold; and
attaching to the second radio network.

7. The method of claim 1, wherein attaching to the first radio network comprises attaching, by the processing system, to a terrestrial radio network, and wherein the attaching to the second radio network comprises dropping an attachment to the terrestrial radio network and attaching, by the processing system, to a non-terrestrial radio network to complete an inter-network handover.

8. The method of claim 1, further comprising:
selecting, by the processing system, a first public land mobile network (PLMN) identifier;
attaching, by the processing system, to the first radio network based on the first PLMN identifier;
selecting, by the processing system, a second PLMN identifier, wherein the selecting the second PLMN identifier is responsive to the comparing the altitude of the UE with the elevation threshold value; and
attaching, by the processing system, to the second radio network based on the second PLMN identifier.

9. The method of claim 8, further comprising:
designating, by the processing system, the first PLMN identifier as a forbidden PLMN identifier, wherein the designating the first PLMN identifier is responsive to the attaching to the second radio network based on the second PLMN identifier.

10. The method of claim 9, comprising:
suspending, by the processing system, attachment to the first radio network by the UE based on the designating the first PLMN identifier as a forbidden PLMN identifier.

11. A device, comprising:
a processing system including a processor; and
a memory that stores executable instructions that, when executed by the processing system, facilitate performance of operations, the operations comprising:
detecting a terrestrial radio network;
determining the terrestrial radio network is a permitted radio network;
attaching to the terrestrial radio network;
monitoring an altitude of the device;
determining the altitude of the device has exceeded an elevation threshold value;
identifying a non-terrestrial radio network as a permitted radio network; and
attaching to the non-terrestrial radio network while de-attaching from the terrestrial radio network; and
communicating with the non-terrestrial radio network.

12. The device of claim 11, wherein the operations further comprise:
determining the terrestrial radio network is a permitted radio network based on a list of permitted public land mobile network (PLMN) identifiers; and
determining the non-terrestrial radio network is a forbidden radio network based on the list of permitted PLMN identifiers; and
preventing attachment to the non-terrestrial radio network based on the determining the non-terrestrial radio network is a forbidden radio network.

13. The device of claim 12, wherein the operations further comprise:
designating the non-terrestrial radio network as a permitted radio network, wherein the designating the non-terrestrial radio network as a permitted radio network is responsive to the determining the altitude of the device has exceeded the elevation threshold value.

14. The device of claim 11, wherein the operations further comprise:
receiving, over one of the terrestrial radio network and the non-terrestrial radio network, an updated elevation threshold value, wherein the updated elevation threshold value is updated based on a location of the device.

15. The device of claim 11, wherein the device comprises one of a drone or a drone incorporating the device for radio communication at locations beyond a visual line of sight for the drone.

16. A non-transitory machine-readable medium, comprising executable instructions that, when executed by a processing system including a processor, facilitate performance of operations, the operations comprising:
attaching, by a radio circuit, to a terrestrial radio network for radio communications with the terrestrial radio network;
monitoring an altitude of the radio circuit relative to a surface of earth; and
attaching, by the radio circuit, to a non-terrestrial radio network for subsequent radio communication with the non-terrestrial radio network to limit radio interference on the terrestrial radio network, wherein the attaching to the non-terrestrial radio network is responsive to the altitude of the radio circuit exceeding a first elevation threshold value.

17. The non-transitory machine-readable medium of claim 16, wherein the operations further comprise:
reattaching, by the radio circuit, to the terrestrial radio network for subsequent radio communication, wherein the reattaching to the terrestrial radio network is responsive to the altitude of the radio circuit falling below a second elevation threshold value, wherein the second elevation threshold value is less than the first elevation threshold value.

18. The non-transitory machine-readable medium of claim 17, wherein the operations further comprise:
receiving, over one of the terrestrial radio network and the non-terrestrial radio network, the first elevation threshold value and the second elevation threshold value.

19. The non-transitory machine-readable medium of claim 16, wherein the operations further comprise:
storing first access permission information for the terrestrial radio network and second access permission information for the-non-terrestrial radio network, wherein the storing comprises storing data in a subscriber identity module (SIM) of the radio circuit;
attaching to the terrestrial radio network based on the first access permission information for the terrestrial radio network; and
attaching to the non-terrestrial radio network based on the second access permission information for the non-terrestrial radio network.

20. The non-transitory machine-readable medium of claim 19, wherein the operations further comprise:
storing a forbidden public land mobile network (PLMN) identifier for the terrestrial radio network as the first access permission information for the terrestrial radio network, wherein the storing the forbidden PLMN identifier for the terrestrial radio network is responsive to the altitude of the radio circuit exceeding the first elevation threshold value.
